(19) United States
(12) Patent Application Publication
(10) Pub. No.: US 2005/0088766 A1
(43) Pub. Date: Apr. 28, 2005

(54) Rear view mirror for a motorcycle

(76) Inventor: John Jerry Daviss, Willow Park, TX (US)

Correspondence Address: JOHN F. BRYAN, 8291 LAKESIDE DRIVE, ENGLEWOOD, FL, 34224, US

(21) Appl. No.: 10/694,497

(22) Filed: Oct. 27, 2003

(51) Int. Cl. G02B 5/08

(52) U.S. Cl. 359/842; 359/871

(57) ABSTRACT

A rear view mirror for attachment at the top edge of a motorcycle windscreen has right and left mirror portions set about a vertical axis of symmetry at an included angle between the mirror backs of less than one hundred and eighty degrees. The mirrors are attached to a bracket conformed to mount on the concave surface at the top edge of a motorcycle windscreen, with attaching members spaced apart to fit the windscreen at two locations.

### TECHNICAL FIELD

The present invention relates to the field of rear view mirrors for motorcycles and more particularly to such devices configured for mounting on a motorcycle windscreen.

### BACKGROUND

Good rearward vision is critical to safety for motorcycle riders. This is particularly true when riding in traffic, where safety is insured only by constant vigilance and awareness of the whereabouts and movements of surrounding vehicles. Rear view mirrors have long been used on motorcycles for this purpose. These mirrors are generally mounted on the handlebars, well below eye level, where they are directed to give a rearward view over the rider's hands and forearms. An alternative arrangement, disclosed by Sakuma, et al. U.S. Pat. No. 4,759,620, has rear view mirrors mounted to extend from the sides of the windscreen fairing, more nearly at eye level. In either arrangement, the rider must briefly take his or her eyes away from the critical forward view. Only a brief glance is needed to update the rider on the traffic changes to the rear, but it also takes another brief time to reacquire the front view. Ordinarily, this is not a problem but then, it only takes an instant for a dangerous situation to develop. The angular adjustment of motorcycle rear view mirrors is set according to the individual rider's needs. As a general rule, because the mirrors have a limited field of view, the rider must choose between good rearward coverage or good side coverage. Most riders will choose a compromise setting, something less than ideal for both side and rear vision.

Outwardly extending rear view mirrors add to the total frontal area of the motorcycle causing increased wind resistance and sometimes buffeting. Such mirrors are mounted on cantilever arms, subject to vibration over and above the vibration of the motorcycle itself. All of this vibration blurs the view, making it more difficult and causing it to take longer to interpret the view in the mirrors.

A first object of the present invention is therefore, to provide a rear view mirror, which is positioned and mounted to be used without requiring that the rider look away from the critical forward view. A second object is to provide this rear view mirror in a form that improves overall side and rear vision. Yet a third object is to provide this rear view mirror in a form and with a mounting that is less subject to distracting vibration.

### SUMMARY OF THE INVENTION

In addressing the aforesaid objectives, the present inventions disclose an improved configuration and mounting for a motorcycle rear view mirror. These inventions relate to or employ some steps and apparatus well known in the motorcycle and rear view mirror arts and therefore, not the subject of detailed discussion herein.

The rear view mirror assembly of the present inventions attaches at the top edge of a motorcycle windscreen by means of a mounting bracket adapted to conform to the concave surface and edge radius of a motorcycle windscreen. Widely spaced attaching members fit to the windscreen at least two locations along its curved top edge for either adhesive or clamped connection. Right and left mirror halves, each having a height of less than three inches, preferably about two inches, and a width of more than three inches, preferably about five inches, are mounted about a vertical axis of symmetry, with the mirror backs at an included angle of one hundred and eighty degrees or less. The mirror halves may abut at the axis of symmetry or may be spaced apart. The mirrors are pivotally attached to the mounting bracket with the backs facing the attaching members and the planes of the mirror halves approximately vertical. A mirror tilt mechanism allows the rider to adjust the vertical angle of both mirrors for the best rearward view.

The rear view mirror of the present inventions is placed approximately at eye level for the rider when installed at the top edge of a motorcycle windscreen. This location requires only a minor shift of focus from the critical forward view. The horizontal angular setting of the mirror halves serves to direct the right and left rear views over the rider's respective shoulder, perhaps showing a bit of each side of the rider's head at the center. This provides an adequate rearward field of view for surveillance of following traffic, without sacrificing awareness of critical events ahead.

The windscreen is stiffened by its curvature, so as to provide a stable mounting platform for mirrors. The vibration prone, cantilevered mass of prior art mirror attachments is avoided by connecting the present invention to the windscreen edge at two places, with the mirror mass cradled in between.

### BRIEF DESCRIPTION OF THE DRAWINGS

The accompanying drawings are incorporated into the specification to assist in explaining the present inventions. The drawings illustrate preferred and alternative examples of how the inventions can be made and used and are not to be construed as limiting the inventions to only those examples illustrated and described. The various advantages and features of the present inventions will be apparent from a consideration of the drawings in which:

FIG. 1 is a view of a preferred embodiment of the rear view mirror of the present inventions as seen from the motorcycle rider's seat;

FIG. 2 is a view of the embodiment of FIG. 1, looking down from above the rider;

FIG. 3 is a detail view of the rear view mirror of FIG. 2, from above, as seen looking along the windscreen rake angle;

FIG. 4 is a detail view of the rear view mirror of FIG. 1;

FIG. 5 is a section view as seen along plane 5-5 of FIG. 4; and

FIG. 6 is a cross-section view as seen along plane 6-6 of FIG. 4.

### DETAILED DESCRIPTION OF THE DRAWINGS

The present inventions are described in the following by referring to drawings of examples of how the inventions can be made and used. In these drawings, reference characters are used throughout the views to indicate like or corresponding parts. The embodiments shown and described herein are exemplary. Details well known in the art may be neither shown nor described.

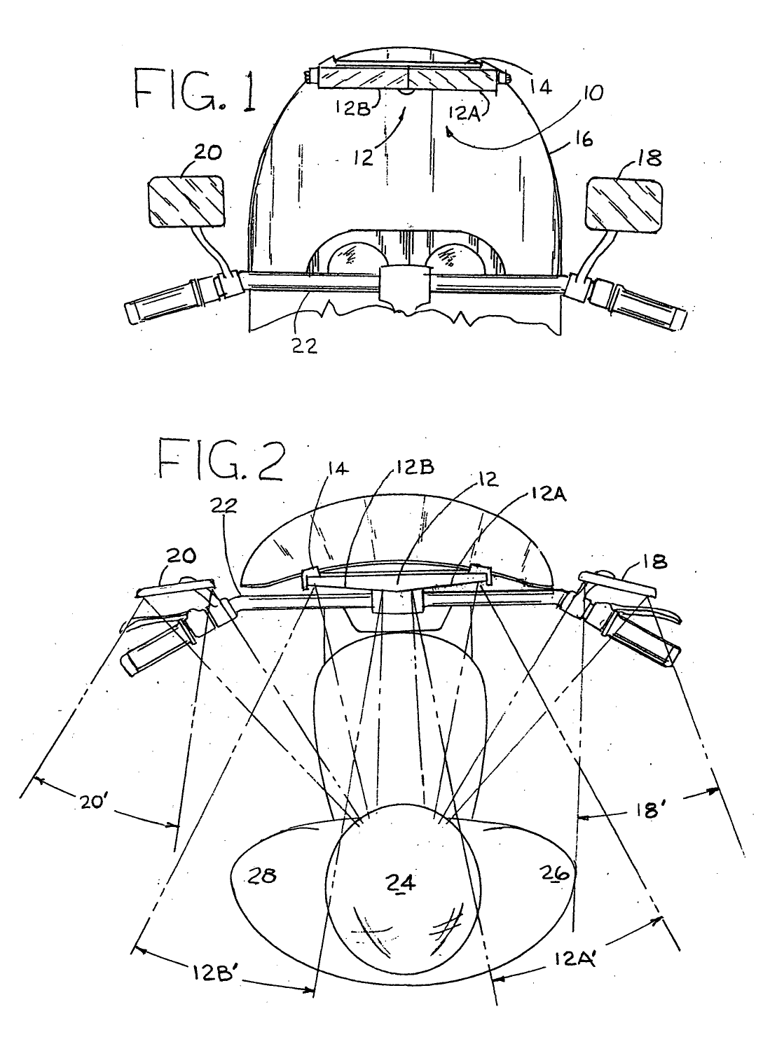

FIGS. 1 and 2 show preferred embodiment 10 of the present inventions in which rear view mirror 12 is seen to comprise right hand mirror portion 12A and left hand mirror portion 12B. Rear view mirror 12 is assembled to mounting bracket 14 for attachment at the top edge of motorcycle windscreen 16. Mirror portions 12A and 12B may abut as shown, or may be spaced apart. Also apparent in these views are prior art rear view right and left hand mirrors 18 and 20 respectively, mounted on handlebar 22.

FIG. 2 shows a plan view of the embodiment of FIG. 1, where the fields of view 12A′ and 12B′ of the right hand and left hand rear view mirror halves 12A and 12B are shown as seen by the rider without head movement. Also shown are the fields of view 18′ and 20′ of prior art mirrors 18 and 20 respectively. Here it is seen that the fields of view 12A′ and 12B′ of the present invention cover the area to the rear, looking over the rider's shoulders 26 and 28, and perhaps showing a little of helmet 24.

In setting the angular adjustment of prior art rear view mirrors, the rider is asked to choose between good rearward coverage or good side coverage. Prior art right hand mirror 18 is shown as it would usually be positioned in the absence of the added viewing capability of the present invention. This mirror angle gives the rider a relatively good rearward field of view 18′, looking outside of the rider's right shoulder 26, but leaves the rider dependent upon sideward glances and peripheral vision to be fully aware of traffic to the side. With the supplementary field of view 12B′, provided by use of the present invention, prior art left hand mirror 20 can be repositioned as shown to afford a wider field of view 20′ to the left side.

FIGS. 3-5 are detail views of the rear view mirror of FIGS. 1 and 2, as seen in various aspects. Bracket 14 includes two widely spaced windscreen attaching members 34, which are separated from the body of mounting bracket 14 by the thickness of windscreen 16 to provide mounting slots 23 for attachment by adhesive or mechanical clamping. Mounted in this manner, the center of mass 15 of preferred embodiment 10 is cradled between the support points of attaching members 34, rather than being carried as an overhung load by a vibration prone cantilever support. Pivot shaft 30 extends across the width of bracket 14, passing through bosses 35 of mirror 12 and lugs 33 at the ends of bracket 14. The threaded ends receive nuts 32, to hold shaft 30 in place.

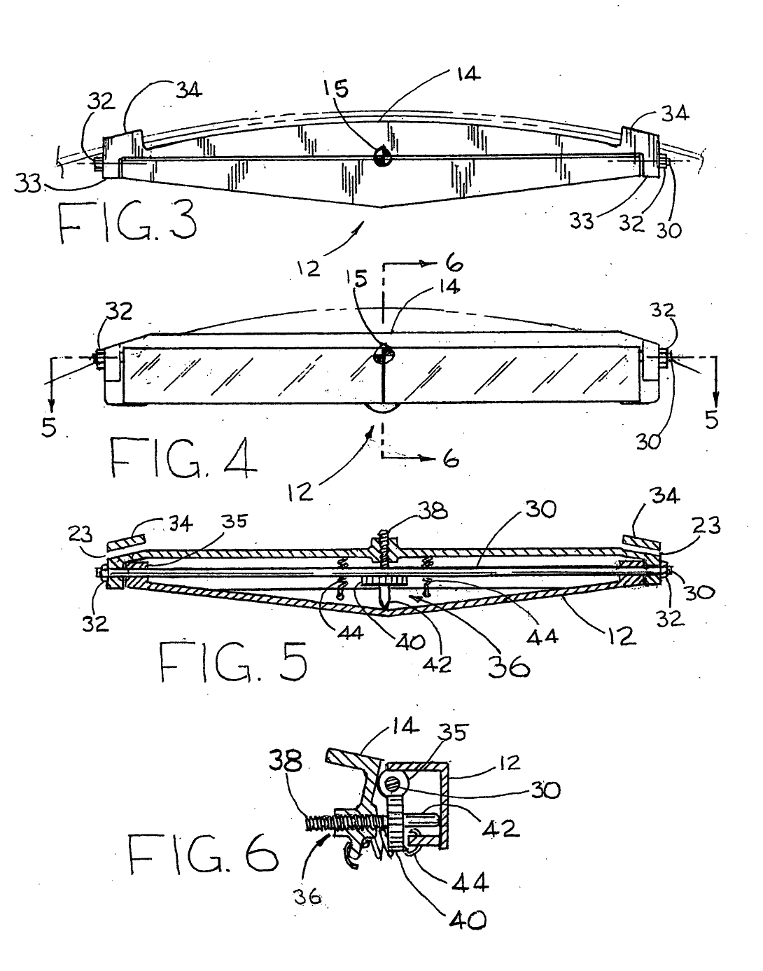

FIGS. 5 and 6 are cross-section views, showing a preferred adjusting mechanism 36 for the vertical tilt angle of mirror 12. One type of adjustment mechanism, preferred for reasons of simplicity and low cost, has an adjustable mechanical stop to trim the vertical angle of mirror 12 by pivoting it about a horizontal axis and an opposing spring to hold mirror 12 in the selected position. The adjustable stop may be provided by an extensable screw or a contoured cam and the stabilizing force may be provided by spring tension or compression. In the preferred embodiment of the present inventions, bull nose end 42 of adjusting screw 38 bears on the back side of mirror 12, which is held in firm contact by tension springs 44. The rider turns adjusting screw 38 by rolling knob 40 so as to tift mirror assembly 12 about pivot shaft 30 and thereby, trim the vertical angle of mirror assembly 12 for the best rearward view.

The embodiments shown and described above are exemplary. It is not claimed that all of the details, parts, elements, or steps described and shown were invented herein. Even though many characteristics and advantages of the present inventions have been described in the drawings and accompanying text, the description is illustrative only. Changes may be made in the detail, especially in matters of shape, size, and arrangement of the parts within the scope and principles of the inventions. The restrictive description and drawings of the specific examples above do not point out what an infringement of this patent would be, but are to provide at least one explanation of how to use and make the inventions. The limits of the inventions and the bounds of the patent protection are measured by and defined in the following claims.

1. A rear view mirror for attachment at the top edge of a motorcycle windscreen comprising:
a motorcycle with a rider;
a mounting bracket adapted to conform to the concave surface and edge contour of the motorcycle windscreen, with attaching members spaced apart to fit to the windscreen at least two locations along the top edge thereof; and
the mirror having right and left mirror portions, each with a height of less than three inches and a width of more than three inches, attached to the bracket about a vertical axis of symmetry, the mirror backs facing the attaching members, with an included angle between the mirror backs of less than one hundred and eighty degrees that will reflect from each mirror, to a centrally disposed rider a rearward view showing a portion of the rider's head.

2. A rear view mirror according to claim 1 wherein the included angle is approximately one hundred and seventy degrees.

3. A rear view mirror according to claim 1 wherein the mounting bracket further comprising:
a horizontal pivotal axis;
a pivotal connection for attachment of the mirror portions to the mounting bracket;
an adjustable mechanical stop to select the mirror angle about the pivotal axis; and
a spring holding the selected mirror angle

4. A rear view mirror according to claim 1 wherein the mounting bracket further comprising:
a horizontal pivotal axis;
at least one pivotal connecting member for attachment of the mirror portions to the mounting bracket; and
a screw threaded member for adjustment of the vertical angle of the mirror portions with respect to the mounting bracket.

5. A rear view mirror according to claim 1 wherein the mounting bracket further comprises windscreen receiving mounting slots.

6. A rear view mirror according to claim 1 wherein the mounting bracket further comprises windscreen attaching members spread apart so that the center of mass of the combined mirror and bracket assembly is located therebetween.

7. A rear view mirror according to claim 1 wherein the right and left portions abut at the axis of symmetry.

8. A rear view mirror according to claim 4 wherein the mounting bracket further comprises a spring member connected to the mirror so as to hold spring force against the screw threaded adjustment member.

9. A rear view mirror according to claim 5 wherein the slots are configured to attach the bracket to the motorcycle windscreen adhesively.

10. A rear view mirror according to claim 5 wherein the slots are configured to attach the bracket to the motorcycle windscreen by clamping.

11. A rear view mirror according to claim 6 wherein the slots are configured to attach the bracket to the motorcycle windscreen adhesively.

12. A rear view mirror according to claim 6 wherein the slots are configured to attach the bracket to the motorcycle windscreen by clamping.

13. A rear view mirror for attachment at the top edge of a motorcycle windscreen comprising:
a motorcycle with a rider;
a mounting bracket adapted to conform to the concave surface and edge contour of the motorcycle windscreen, with attaching members spaced apart to fit to the windscreen at least two locations along the top edge thereof; and
the mirror having right and left mirror portions mounted to the bracket about a vertical axis of symmetry, with an included angle between the mirror backs of less than one hundred and eighty degrees and reflecting, from each mirror to a centrally disposed rider, a view showing a portion of the rider's head.

14. A rear view mirror according to claim 13 wherein the mounting bracket further comprising:
a horizontal pivotal axis;
a pivotal connection for attachment of the mirror portions to the mounting bracket;
an adjustable mechanical stop to select the mirror angle about the pivotal axis; and
a spring holding the selected mirror angle

15. A rear view mirror according to claim 13 wherein the mounting bracket further comprising:
a horizontal pivotal axis;
at least one pivotal connecting member for attachment of the mirror portions to the mounting bracket; and
a screw threaded member for adjustment of the vertical angle of the mirror portions with respect to the mounting bracket.

16. A rear view mirror according to claim 13 wherein the mounting bracket further comprises windscreen receiving mounting slots.

17. A rear view mirror according to claim 13 wherein the mounting bracket further comprises windscreen attaching members spread apart so that the center of mass of the combined mirror and bracket assembly is located therebetween.

18. A rear view mirror according to claim 13 wherein the right and left portions abut at the axis of symmetry.

19. A method for enabling a motorcycle rider to view activity to the rear of the motorcycle comprising the steps of:
providing a rearview mirror located at the top edge of the motorcycle windscreen;
dividing the mirror symmetrically into a right hand portion and a left hand portion;
angling the left hand portion to reflect a view over the rider's left shoulder so as to include a partial view of the rider's head; and
angling the right hand portion to reflect a view over the rider's right shoulder so as to include a partial view of the rider's head.
